(19) United States
(12) Patent Application Publication
(10) Pub. No.: US 2007/0215173 A1
(43) Pub. Date: Sep. 20, 2007

(54) Heated single wafer megasonic processing plate

(76) Inventors: Paul V. Mendes, Sunnyvale, CA (US); Kenneth C. Struven, Sunnyvale, CA (US); Michael Olesen, Sunnyvale, CA (US)

Correspondence Address: ZIMMERMAN & CRONEN, LLP, 1330 BROADWAY, SUITE 710, OAKLAND, CA, 94612-2506, US

(21) Appl. No.: 11/725,105

(22) Filed: Mar. 16, 2007

Related U.S. Application Data
(60) Provisional application No. 60/783,752, filed on Mar. 17, 2006.

(51) Int. Cl. B08B 3/12; B08B 6/00; C23G 1/00

(52) U.S. Cl. 134/1; 134/1.3; 134/2

(57) ABSTRACT

A method and apparatus for heating a megasonic wafer processing plate to approximate the temperature of the processing liquid, whereby the chemical processing of the wafer is optimized. Heater blankets may be secured to the back side of the megasonic plate, or internal heating elements or passages may be disposed within the plate.

### CROSS-REFERENCE TO RELATED APPLICATIONS

This application claims the benefit of the priority date of Provisional Application No. 60/783,752, filed Mar. 17, 2006.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to a method and apparatus for megasonic cleaning and, more particularly, to the cleaning of single wafer substrates in the production of integrated circuits.

2. Description of Related Art

In the production and manufacture of electrical components, it is a recognized necessity to be able to clean, etch or otherwise process substrates to an extremely high degree of cleanliness and uniformity. Various cleaning, etching, or stripping processes may be applied to the substrates a number of times in conjunction with the manufacturing steps to remove particulates, predeposited layers or strip resist, and the like.

One cleaning process that is often employed involves ultrasonic cleansing; that is, the application of high amplitude ultrasonic energy to the substrates in a liquid bath. More specifically, the ultrasonic energy is generally in the range of 0.60-10.00 MHz, and the process is termed megasonic cleaning. The liquid bath may comprise deionized water, standard cleaning solutions, dilute NH₄OH:H₂O₂ (SC-1), dilute HF, or the like. The amplitude and the length of time of application of the sonic energy are generally well known in the prior art

In the process of cleaning large single substrates, it is common practice to immerse the substrate in a tank filled with an appropriate solution, and to immerse a megasonic transducer in close proximity to the substrate, the acoustic output being coupled to the surface of the substrate by the solution. The wafer may be rotated to utilize a transducer smaller in output area than the wafer, and to distribute the sonic energy uniformly over the surface undergoing cleaning. Typically, the transducer is mounted on a megasonic processing resonator plate that optimizes the transfer of acoustic energy to the wafer.

Megasonic processing techniques have been developed to the point where they have been performing in accordance with the demands of current wafer processing techniques. However, more stringent requirements for etch uniformity have emerged that require better control of the chemical processes involved. The present invention provides a means of providing process temperature control that has been the missing link in attaining significant process improvements in uniformity, efficiency and predictability.

The typical megasonic processing plate is comprised of a multiplicity of sonic transducers mounted on a resonator plate of significant mass. The resonator plate itself may be formed of various materials, quartz and coated aluminum being two typical choices. Typically the megasonic resonator plates are provided with chemical delivery holes for delivering the active liquids to the surface of the wafer being treated. When the heated process liquid enters through these holes, it flows between the resonator plate and the silicon wafer, outwards toward the edges of the plate. If the plate is cold relative to the entering fluid, the chemistry cools in its journey from mid-area to the edge of the plate. This differential temperature profile may create non-uniform etch characteristics of the wafer as well as lot-to-lot variations in quality. To achieve a desired result of improved process control, it is crucial that the large mass of the megasonic processing plates be heated and controlled to a stable set point temperature. With temperature control added to the megasonic processing plates, control of the processing chemistry temperature from center to edge of the wafer is accomplished, yielding far superior results.

### BRIEF SUMMARY OF THE INVENTION

The present invention generally comprises a method and apparatus for heating a megasonic wafer processing plate to approximate the temperature of the processing liquid, whereby the chemical processing of the wafer is optimized. A major beneficial attribute of the heated megasonic plate is achieving improved native-oxide etch rate uniformity which in many different aspects contributes, in aggregate, to the improved performance of the process tool in which the megasonic process plate is incorporated. One aspect of this superior etch-rate uniformity is wafer-to-wafer uniformity. A second aspect is the etch-rate uniformity improvement across the surface of each unique wafer: from one region to another region within the wafer the etch uniformity is improved. A third aspect is that a single-wafer tool having multiple chambers for parallel processing capability provides superior uniformity of etch among the multiple chambers. Another aspect is the etch rate uniformity that is held from one lot of wafers to subsequent lots, contributing to process predictability.

Another major attribute of the invention is the enhanced uniformity and efficiency of wafer cleaning using the heated megasonic process plate. With the stabilization of temperature across the megasonic process plate the cleaning of particles has been shown to be extremely uniform across the wafer with greater (higher efficiency) particle removal.

A further major attribute of the invention is the increase in process throughput. In single wafer processing tools, there is a constant need to move as many wafers as possible through the tool per unit time. The heated megasonic technology can provide elevated plate/chemistry operating temperatures which, in turn, result in shorter processing times in many of the typical wafer processing steps.

In one embodiment the megasonic plate is provided with a piezoelectric acoustic transducer on the back side of the plate, and at least one surface mounted heater blanket on the same back side to heat the plate. The heater blanket may comprise a silicon coated etched-foil resistive blanket heater, and temperature sensors may be added to the back side to enable precise control of the plate temperature, whereby the plate may be operated at the same temperature as the process liquid. The heater blanket may comprise a plurality of heater blankets secured to the back side in patch-like fashion, or a single annular blanket having an outer diameter approximating the outer diameter of the plate. The annular blanket may be donut shaped, with a central opening, or may comprise a disk-like sheet that covers substantially all of the back side of the plate.

In a further embodiment the plate may be provided with a plurality of resistive heating element rods embedded within the resonator plate and spaced apart to provide a uniform heating effect within the plate. In another embodiment the invention may provide a plurality of passages or tubes embedded in the plate and connected to a source of heated fluid such as hot water, steam, or other heated liquid (including the heated process liquid itself).

In all of the embodiments of the invention, the wafer may be supported on a rotating wafer chuck in close proximity to the front surface of the plate. The chuck and the megasonic plate are provided with apertures extending generally coincident with the axis of the chuck and plate to emit hot and cold process liquid toward the wafer. The wafer is spaced slightly apart from the chuck to define a flow space for the liquid emitted from the chuck aperture, and the wafer is spaced slightly apart from the megasonic plate to define a flow space for the liquid emitted from the plate aperture, whereby the wafer is bathed in process liquid on both sides as the megasonic treatment is carried out.

In all of the embodiments, the megasonic process plate is provided with an axially extending aperture through which the process liquid may be pumped, so that the wafer surface confronting the process plate is bathed in a constant flow of heated process liquid. This flow carries away the dissolved and particulate contaminants that are liberated by the megasonic energy, so that the cleaning process is optimized with minimal damage to the wafer surface or substrate.

### BRIEF DESCRIPTION OF THE DRAWING

FIG. 1 is a plan view of a wafer disposed to undergo megasonic processing in conjunction with a megasonic resonator process plate.

FIG. 2 is a cross-sectional elevation taken along line 2-2 of FIG. 1, showing one embodiment of the heated single wafer megasonic processing assembly of the present invention.

FIG. 3 is a bottom plan view of the megasonic processing assembly depicted in FIG. 2.

FIG. 4 is a cross-sectional elevation similar to FIG. 2, depicting a further embodiment of the heated single wafer megasonic processing assembly of the present invention.

FIG. 5 is a bottom plan view of the megasonic processing assembly depicted in FIG. 4.

FIG. 6 is a cross-sectional elevation similar to FIG. 4, depicting a further embodiment of the heated single wafer megasonic processing assembly of the present invention.

FIG. 7 is a bottom plan view of the megasonic processing assembly depicted in FIG. 6.

FIG. 8 is a cross-sectional elevation similar to FIG. 6, depicting a further embodiment of the heated single wafer megasonic processing assembly of the present invention.

FIG. 9 is a bottom plan view of the megasonic processing assembly depicted in FIG. 8.

FIG. 10 is a cross-sectional elevation similar to FIG. 8, depicting a further embodiment of the heated single wafer megasonic processing assembly of the present invention.

FIG. 11 is a bottom plan view of the megasonic processing assembly depicted in FIG. 10.

FIG. 12 is a cross-sectional elevation depicting a typical manner of supporting a single wafer in conjunction with any of the embodiments of the heated megasonic processing assembly of the present invention.

FIG. 13 is a graph depicting process liquid temperature versus location on a megasonic transducer plate, comparing the temperature gradient of a typical prior art plate and the present invention.

FIG. 14 is a graph depicting temperature differences at specific plate locations versus time for a megasonic transducer plate, comparing a typical prior art plate and the present invention.

FIG. 15 is a graph depicting temperature versus time in a typical prior art megasonic process using an unheated megasonic transducer plate.

FIG. 16 is a graph depicting temperature versus time of a megasonic process using the heated megasonic transducer plate of the invention.

### DETAILED DESCRIPTION OF THE INVENTION

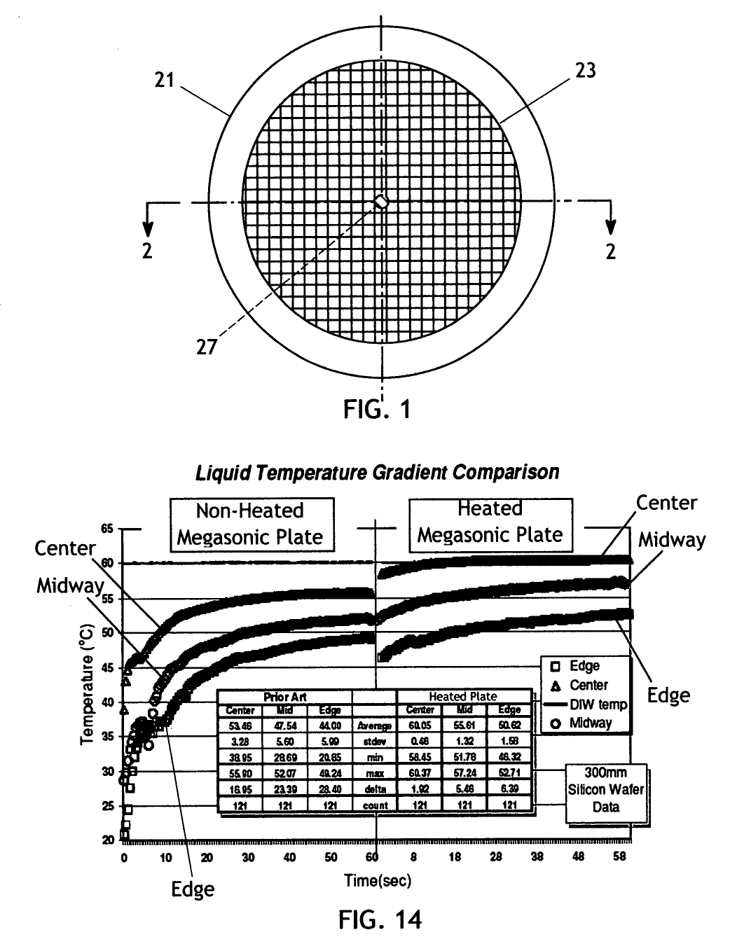

The present invention generally comprises a method and apparatus for heating a megasonic wafer processing plate to approximate the temperature of the processing liquid, whereby the chemical processing of the wafer is optimized. With regard to FIGS. 1-3, one embodiment of the apparatus of the invention includes a megasonic resonator process plate 21 comprised of a disk-like device formed of a solid material such as quartz or aluminum provided with a chemically inert coating. The front surface 22 of the plate 21 is disposed in close proximity to a wafer 23 undergoing processing within a process chamber (not shown). A piezoelectric transducer 24 is secured in a recess 26 formed in the back side of the plate 21, and disposed at an angle thereto to optimize the transfer of acoustic energy into and through the plate 21 to the wafer 23. The plate 21 is provided with an opening 27 extending axially therethrough, the opening being connected to a source of process liquid. The liquid flows toward the front surface of the plate 21 and radially outwardly in the narrow space between the wafer 23 and plate 21, whereby the wafer surface is bathed in process liquid as the wafer is irradiated with megasonic energy from plate 21. These features are generally known in the prior art.

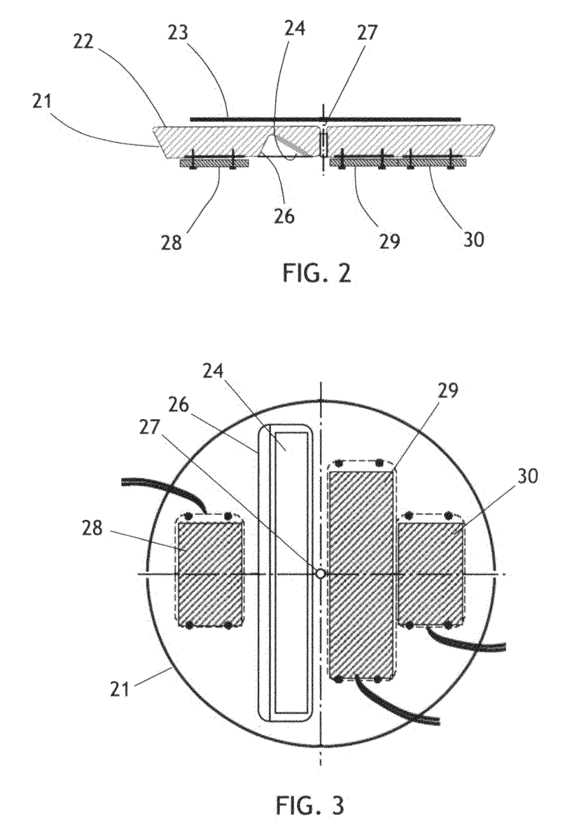

With particular regard to FIGS. 2 and 3, the invention provides a plurality of heater blankets 28, 29, and 30, secured to the back side of the plate 21. The blankets 28-30 are secured to the plate 21 by any fastener known in the prior art, or by adhesive means, with the proviso that the fasteners must be inert with respect to the chemistry in which the processing takes place. In this embodiment the fastening arrangement comprises alumina silica insulation pads which in turn are held firmly in place by PVDF panels secured by screws to the plate 21. In one instantiation, the heater blankets are comprised of silicone-coated etched-foil resistive blankets in generally rectangular conformations and constituted to produce approximately 10 watts/in². The size and placement of the heater blankets is chosen to distribute the thermal energy as uniformly as possible throughout the plate 21. For a plate 21 of typical dimensions, the three heater blankets produce a total of 600 watts of thermal energy, which for many aqueous chemistries will enable heating the plate 21 from room temperature to 60° C. in less than 30 minutes. Thus the plate is heated to and maintained at a temperature that closely approximates the temperature of the process liquid used to treat the wafer. The result in a marked improvement in the outcome of the processing of the wafer, as detailed elsewhere in this specification. (Note that all the embodiments described herein, despite their differing configurations and operating principles, are arranged to impart similar thermal energy in a similar temperature range to the plate 21.)

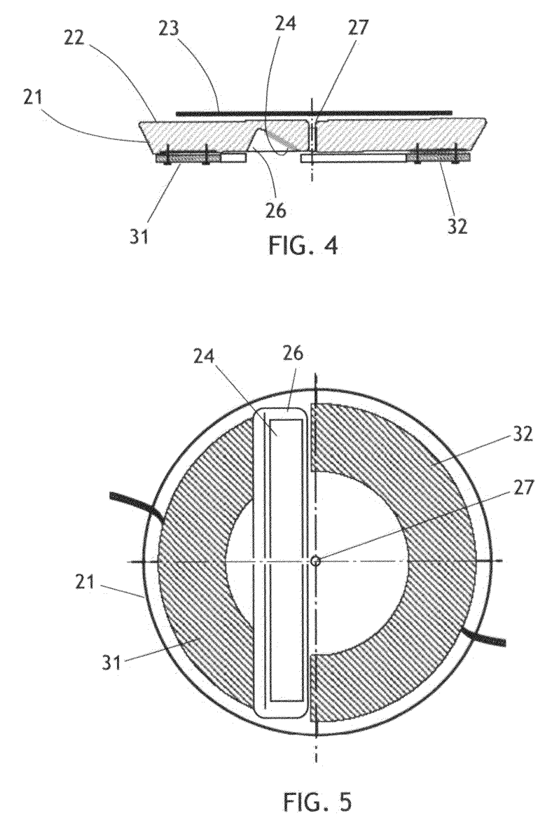

With regard to FIGS. 4 and 5, a further embodiment of the invention is applied to the megasonic plate 21 as described previously, including the features of reference numerals 22-24 and 26-27. In this embodiment the plate 21 is heated by a pair of surface mounted heater blankets 31 and 32 secured to the back side of the plate 21 by any means described with regard to the previous embodiment. The two heater blankets 31 and 32 together define an annular shape that is interrupted by the recess 26; that is, each heater blanket forms a portion of a ring shape. The heater blankets may consist of the same heater devices as described previously, and their shape provides a uniform heating effect throughout the plate 21, whereby the processing liquid traverses a generally unvarying temperature gradient as it flows outwardly between the surface 22 and the wafer 23. Thus the uniformity of the processing created by the combination of the processing liquid and the megasonic energy field is optimized.

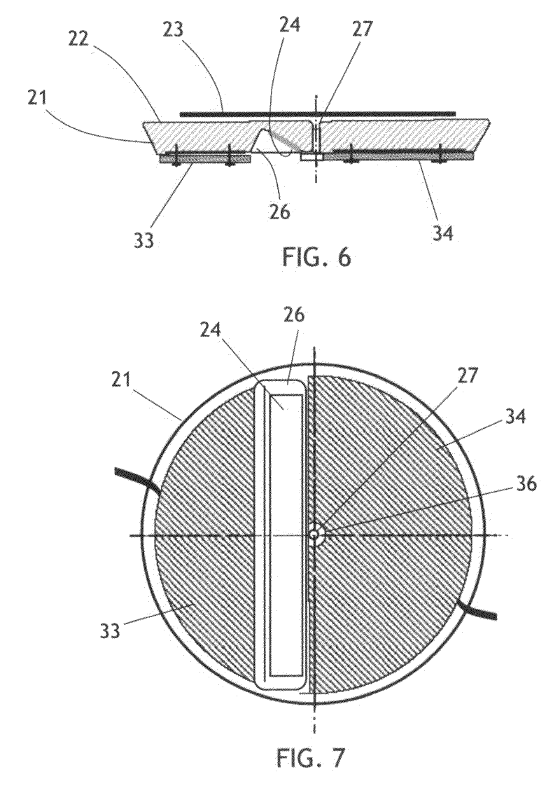

With reference to FIGS. 6 and 7, another embodiment of the invention is applied to the megasonic plate 21 as described previously, including the features of reference numerals 22-24 and 26-27. Secured to the back side of plate 21 is a pair of heater blankets 33 and 34 that are configured to cover substantially all of the back side, except for the recess 26 in which the piezoelectric transducer 24 is supported. That is, the two heater blankets 33 and 34 have outer peripheral edges that are generally circular and adjacent to the outer edge of the plate 21, and confronting inner edges that border the recess 26. Note that heater blanket 34 covers slightly more than one-half of the back side of the plate 21, and an access opening 36 extends therethrough aligned with the opening 27 to permit a fluid connection to the opening 27. The heater blankets 33 and 34 may consist of the same heater devices as described previously, and their shape provides a uniform and maximum heating effect throughout the plate 21, whereby the processing liquid traverses a generally unvarying temperature gradient as it flows outwardly between the surface 22 and the wafer 23. Thus the uniformity of the processing created by the combination of the processing liquid and the megasonic energy field is optimized. The heater blankets are formed as described in previous embodiments, and are secured by any means mentioned previously.

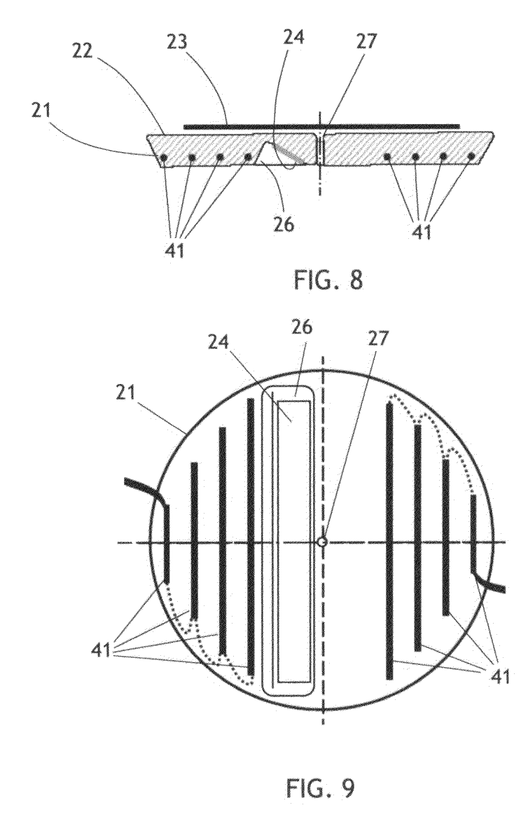

With reference to FIGS. 8 and 9, another embodiment of the invention is applied to the megasonic plate 21 as described previously, once again including the features of reference numerals 22-24 and 26-27. In this embodiment the megasonic process plate 21 is provided with a plurality of heating rods 41 embedded in the plate 21 to heat the plate to the process temperature. The rods 41 are arranged in a parallel array on either side of the recess 26, and are each dimensioned to have a length slightly less than a chord of the circular periphery of the plate 21. The rods are spaced apart generally equally, and may comprise electrically energized heat generating elements, formed of conductive materials that have a known resistance, such as quartz rods and the like. The rods may be connected in series or parallel circuits. The rods 41 may be received in holes bored into the plate 21 parallel to the end surfaces and then plugged, or the plate 21 may be assembled from two disks having channels machined in confronting surfaces thereof to receive the rods within the channels. In either case it is noted that in this arrangement the heating rods are not subject to contact with the process liquid and not vulnerable to the chemistry thereof. It may be appreciated that the number and arrangement of the heating rods may be selected to provide the best distribution of thermal energy within the plate to achieve the optimal heating thereof.

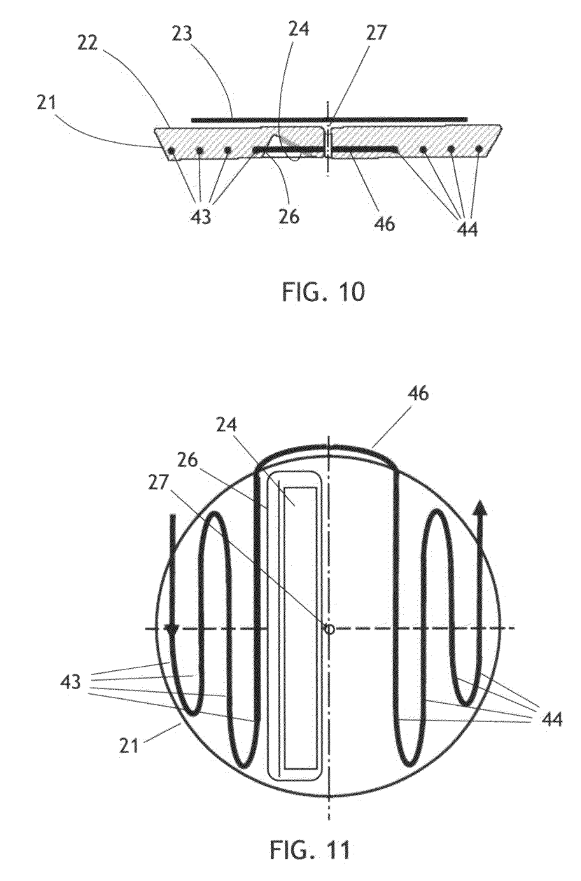

With reference to FIGS. 10 and 11, another embodiment of the invention is applied to the megasonic plate 21 as described previously, once again including the features of reference numerals 22-24 and 26-27. The plate 21 is heated by a plurality of internal passages 43 and 44 disposed on either side of the recess 26 and spaced apart in a generally parallel array. The passages are connected end-to-end to form a continuous flow path, and a connector 46 joins the two passages 43 and 44 to define a single continuous flow path through all the passages 43 and 44. The internal passages extend generally parallel to the upper and lower surfaces of the plate 21, and may be formed by boring into the plate multiple times and plugging the open ends to form the serial flow paths. Alternatively, the plate 21 may be assembled from two confronting disks, one or both of which is provided with channels that define the closed flow paths when the disks are assembled and the channels are sealed thereby. In either case it is noted that in this arrangement the passages are not subject to contact with the process liquid and not vulnerable to the chemistry thereof, and the connector 46 may comprise a tube or pipe formed on material that is inert with respect to the process chemistry being used. The passages may be connected to transport any heated fluid, such as, but not limited to, hot water, steam, or the heated process liquid in which the megasonic plate is immersed, so that the plate 21 is heated uniformly to the temperature of the process bath.

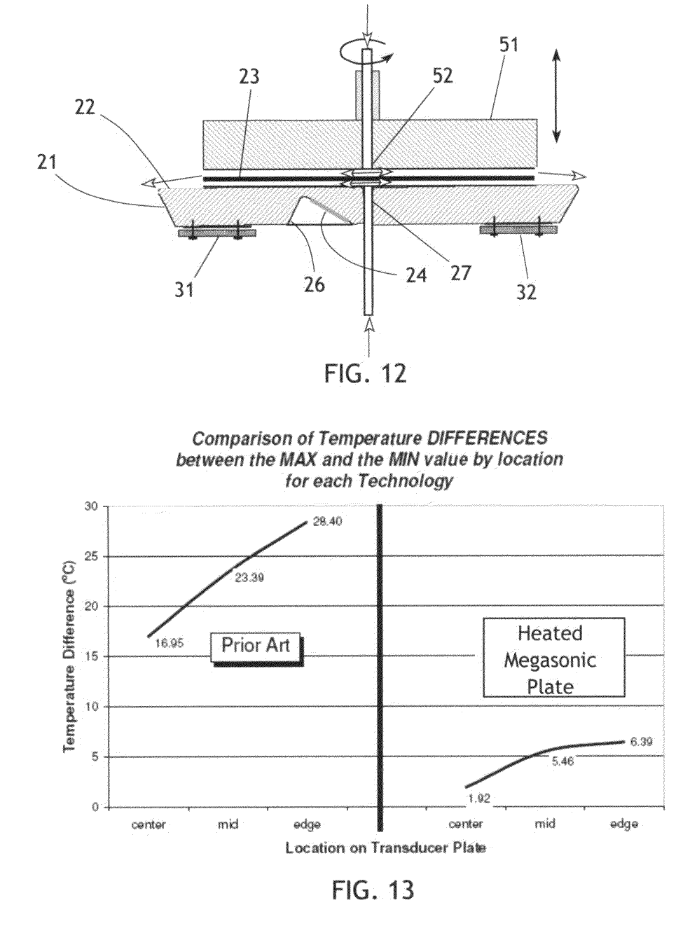

With regard to FIG. 12, there is shown a typical arrangement for supporting a wafer in conjunction with any of the embodiments of the invention. The wafer 23 is supported on a chuck 51 that is adapted to rotate about the axis of the wafer, and also to be translated along that axis to move the wafer into close proximity to the front surface 22 of the plate 21. The chuck is provided with a fluid supply port 52 extending therethrough along the axis to supply process fluid to the confronting surface of wafer 23, and the opening 27 in plate 21 is likewise connected to a supply of process fluid, whereby both surfaces of the wafer 23 are bathed in process fluid as the wafer is rotated in close proximity to the megasonic process plate. The process liquid flows radially outwardly in the narrow spaces between the front surface 22 and the wafer 23, and between the chuck and the wafer 23. The rotating motion of the wafer distributes the megasonic energy and the process fluid in a very uniform manner across the surfaces of the wafer, and the heated plate 21 assures maximum uniformity in the interaction of these dynamic factors.

FIG. 13 displays a graph that depicts a comparison of typical prior unheated megasonic plate technology, and the heated megasonic process plate of the present invention. It compares the temperature differences between the maximum and minimum temperature values for the center, middle, and edge locations of the plate. Note that for the heated megasonic plate of the invention the temperature differences are significantly reduced, by factors in the range of approximately 48, indicating an improvement in temperature difference that is extremely meaningful.

Likewise, FIG. 14 depicts two plots of temperature versus time for typical prior art non-heated megasonic plates, showing measurements of the liquid temperature between the wafer and the megasonic plate as a function of time and radial position on the plate. All conditions are the same except for the use of the heated plate versus the prior art non-heated plate. It is significant that the prior art typically requires a long time to bring the process liquid up to the optimal temperature (i.e., 60° C.), whereas the heated plate of the invention is at a stable temperature close to the optimal temperature with a few seconds. Thus the processing undertaken with the invention is greatly improved. Note that temperature sensors may be added to the back side of the megasonic processing plate to monitor and control the thermal energy applied to the megasonic plate.

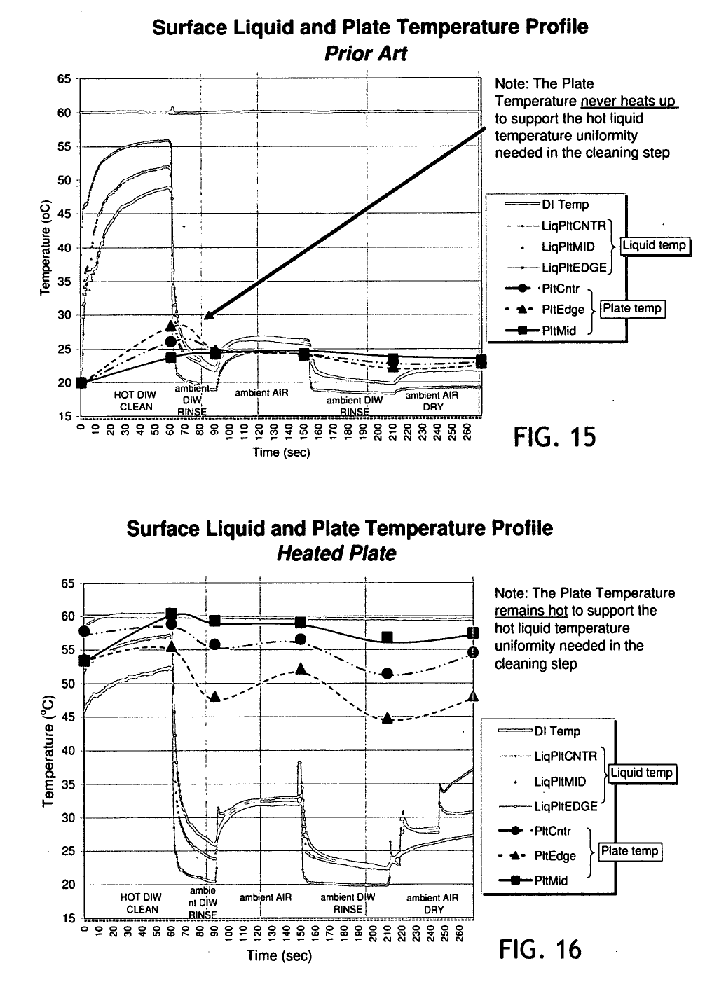

FIG. 15 is a graph depicting the temperature versus time relationship of a typical prior art megasonic transducer plate that is unheated. Note that the plate temperature, whether center, edge, or midpoint, never heats up to the process liquid temperature. Thus, although the initial hot deionized water (DIW) cleaning step does heat the plate to some extent, it quickly returns to approximately the temperature of the ambient DIW rinse and air dry steps. In contrast, as shown in FIG. 16, the heated megasonic transducer plate of the invention remains hot to support hot liquid temperature uniformity needed in the cleaning step, resulting in improved cleaning, improved uniformity across the wafer, and improved uniformity on a wafer-to-wafer basis.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A megasonic transducer processing plate assembly for wafer processing,
said plate assembly having a front surface in close proximity to a wafer undergoing processing, and an back surface, and a central opening for delivering process liquid to said wafer;
heating means for heating said processing plate to approximate the elevated temperature of the process liquid,
said heating means including at least one heater blanket secured to said back surface of said processing plate.

2. The megasonic transducer processing plate assembly of claim 1, wherein said heating means includes a plurality of said heater blankets disposed in a patch-like array on said back surface of said processing plate.

3. The megasonic transducer processing plate assembly of claim 1, wherein said heating means includes a pair of heater blankets, each forming a portion of an annular shape and disposed in combination to define an annular heating assembly.

4. The megasonic transducer processing plate assembly of claim 1, wherein said heating means includes a pair of heater blankets, each forming a portion of a disk-like shape and disposed in combination to extend over a substantial portion of said back surface.

5. The megasonic transducer processing plate assembly of claim 1, wherein said heater blanket includes an etched-foil resistive pad.

6. The megasonic transducer processing plate assembly of claim 5, further including an alumina silica insulation pad joined to an outer surface of said resistive pad.

7. The megasonic transducer processing plate assembly of claim 6, further including a PVDF panel secured to an outer surface of said insulation pad.

8. The megasonic transducer processing plate assembly of claim 1, further including a plurality of said heater blankets arranged on said back surface to distribute thermal energy to said processing plate in an optimally uniform manner.

9. A megasonic transducer processing plate assembly for wafer processing in a liquid bath,
said plate assembly having a front surface in close proximity to a wafer undergoing processing, and an back surface, and a central opening for delivering process liquid to said wafer;
heating means for heating said processing plate to approximate the elevated process temperature of the liquid,
said heating means being embedded within said processing plate.

10. The megasonic transducer processing plate assembly of claim 9, wherein said heating means includes at least one resistance heating rod embedded in said processing plate.

11. The megasonic transducer processing plate assembly of claim 10, further including a plurality of said resistance heating rods arrayed in said processing plate to distribute thermal energy to said processing plate in an optimally uniform manner.

12. The megasonic transducer processing plate assembly of claim 9, wherein said heating means includes at least one flow passage embedded in said processing plate and arranged to be connected to a source of heated fluid.

13. The megasonic transducer processing plate assembly of claim 12, further including a plurality of said flow passages embedded in said processing plate and connected to define a continuous flow path therethrough, said flow passages arrayed in said processing plate to distribute thermal energy to said processing plate in an optimally uniform manner.

14. A method for megasonic processing of wafers in a liquid bath, including the steps of:
providing a megasonic processing plate in close proximity to one surface of a wafer;
heating said processing plate to a temperature approximating the process temperature of said liquid;
pumping processing liquid through an opening in said processing plate toward said one surface of said wafer.

15. The method for megasonic processing of claim 14, wherein said heating step includes securing at least one heater blanket to said megasonic plate to distribute thermal energy to said processing plate in an optimally uniform manner.

16. The method for megasonic processing of claim 14, wherein said heating step including providing an embedded heater in said processing plate to distribute thermal energy to said processing plate in an optimally uniform manner.

17. The method for megasonic processing of claim 16, wherein said embedded heater includes at least one resistance heating rod secured within said megasonic processing plate.

18. The method for megasonic processing of claim 16, wherein said embedded heater includes at least one flow passage within said megasonic processing plate and connected to a source of heated fluid.
